(19) United States
(12) Patent Application Publication
(10) Pub. No.: US 2009/0222522 A1
(43) Pub. Date: Sep. 3, 2009

(54) METHOD AND SYSTEM OF ORGANIZING AND SUGGESTING ACTIVITIES BASED ON AVAILABILITY INFORMATION AND ACTIVITY REQUIREMENTS

(76) Inventor: Wayne Heaney, San Luis Obispo, CA (US)

Correspondence Address: SCHWEGMAN, LUNDBERG & WOESSNER, P.A., P.O. BOX 2938, MINNEAPOLIS, MN, 55402, US

(21) Appl. No.: 12/039,813

(22) Filed: Feb. 29, 2008

(51) Int. Cl. G06F 15/16

(52) U.S. Cl. 709/206; 709/204

(57) ABSTRACT

Activities may be automatically organized and suggested to members of a network based at least on interest information and availability information. A suggested activity may be confirmed or canceled based on attendance information received from the members.

### TECHNICAL FIELD

The present invention is generally directed to methods and systems of enabling members of communities to participate in activities, and more particularly to software tools and techniques to schedule the activities for and to suggest the activities to the members of the communities.

### BACKGROUND

The popularity of the Internet and communities has created new generations of applications tools. The application tools may enable the members of the communities to form new friendships, share ideas, and keep in touch with one another. Popular communities such as MySpace of Beverly Hills, Calif. and Facebook of Palo Alto, Calif. have millions of members. One of the challenges of the communities is to continue to develop new services and tools to maintain loyalties the current members and to attract new members.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the embodiments of the present invention, reference will be made to the following Detailed Description, which is to be read in association with the accompanying drawings, wherein:

FIG. 1 is an example network diagram that may be used, in accordance with some example embodiments;

FIG. 2 is another example of a community, in accordance with some example embodiments;

FIG. 3 is a block diagram that illustrates examples of various database tables that may be used, in accordance to some example embodiments;

FIG. 4 is a block diagram that illustrates an example of the various modules that may be included in an activity organizing application, in accordance with some example embodiments;

FIG. 5 is a block diagram that illustrates some specific examples related to automatically organizing an activity for the members of a community, in accordance with some example embodiments;

FIG. 6 illustrates an example interface that may be used to specify interest information and availability information, in accordance with some example embodiments;

FIG. 7A illustrates an example interface that may be used to create activities, in accordance with some example embodiments;

FIG. 7B illustrates an example interface that may be used to request for an activity, in accordance with some example embodiments;

FIG. 8 illustrates an example interface that may be used by an activity organizing application to suggest one or more activities, in accordance with some example embodiments;

FIG. 9 is an example flow diagram that illustrates a process that may be performed by an activity organizing application to automatically organize an activity, in accordance with some example embodiments;

FIG. 10 is an example flow diagram that illustrates a process that may be performed by an activity organizing application to organize an activity initiated by a member, in accordance with some example embodiments;

FIG. 11 illustrates an example diagram of a representation of a machine in the example form of a computer system that may be used, in accordance with some example embodiments.

### SUMMARY OF THE INVENTION

In light of the above and according to one broad aspect of one embodiment of the present invention, disclosed herein is a method and system for organizing activities for members of a community. In one embodiment, an activity may be organized by using the interest information, availability information, specific date and time information and invitee information. Notifications may be sent to the invitees who share the same interest information, and who are available to participate in the activity at a specific date and time.

According to another broad aspect of another embodiment of the present invention, disclosed herein is method and system for organizing activities based on interest information and ranges of dates and times. Members of a network who share the same interest information and who may be available during the ranges of dates and times may be identified. Members may be further selected based upon location information and may receive notifications about a suggested activity.

According to another broad aspect of the present invention, disclosed herein is a method and system for automated organization of activities based on interest information and availability information. The interest information and the availability information of multiple members of a network may be evaluated to match the members who share the same interests. Their availability information may then be evaluated to match the members who may be available during similar time blocks. Other factors may also be evaluated before the activities are placed into the schedules of the members.

According to another broad aspect of the present invention, disclosed herein is a method and system for automated organization of activities based on interest information and availability information. The system may include a processor, an activity organizing module coupled to the processor and a database coupled to the activity organizing module. The database may include interest information and availability information of multiple members of a community. The activity organizing module may be configured to use the information in the database to automatically organize activities for the members of the community.

Embodiments of the invention may extend to a machine-readable medium for performing any one or more of the methodologies described herein. Other features will be apparent from the accompanying drawings and from the detailed description that follows.

### DETAILED DESCRIPTION

For some example embodiments, methods and systems for organizing and suggesting activities based on interest information and availability information of members of a network are disclosed. The interest information and the availability information may be provided by the members. An activity may be suggested by the network. Upon receiving sufficient positive attendance information from the members, the activity may be confirmed.

The disclosure will be described more fully hereinafter with reference to the accompanying drawings, which form a part hereof, and which show, by way of illustration, specific exemplary embodiments by which the invention may be practiced.

The disclosure may, however, be embodied in many different forms and should not be construed as limited to the embodiments set forth herein; rather, these embodiments are provided so that the disclosure will be thorough and complete, and will fully convey the scope of the example embodiments to those skilled in the art. The disclosure may be embodied as methods, apparatuses, devices, systems, or networks. Accordingly, the disclosure may be implemented in hardware, software, or a combination of hardware and software. The following detailed description is, therefore, not to be taken in a limiting sense.

It may be noted that the phrases “in one example embodiment” and “in some example embodiments” as used herein do not necessarily refer to the same embodiment, although it may. Similarly, the phrases “in another example embodiment” and “in some other example embodiments” as used herein do not necessarily refer to a different embodiment, although it may. The term “based on” is not exclusive and provides for being based on additional factors not described, unless the context clearly dictates otherwise.

### Introduction

Members of communities may be able communicate with one another, share information, and establish friendships. When the members are geographically close to one another, they may take their online friendships offline for in-person get together. This may be sufficient for a small group of members. It is often difficult to schedule meetings or activities when there are many members. This may be because each member's interest information and availability information may be different. Some example embodiments of the present invention may provide tools to enable manual or automated activity scheduling to allow multiple members of a network to participate in activities when they are all available to participate.

### Network Diagram

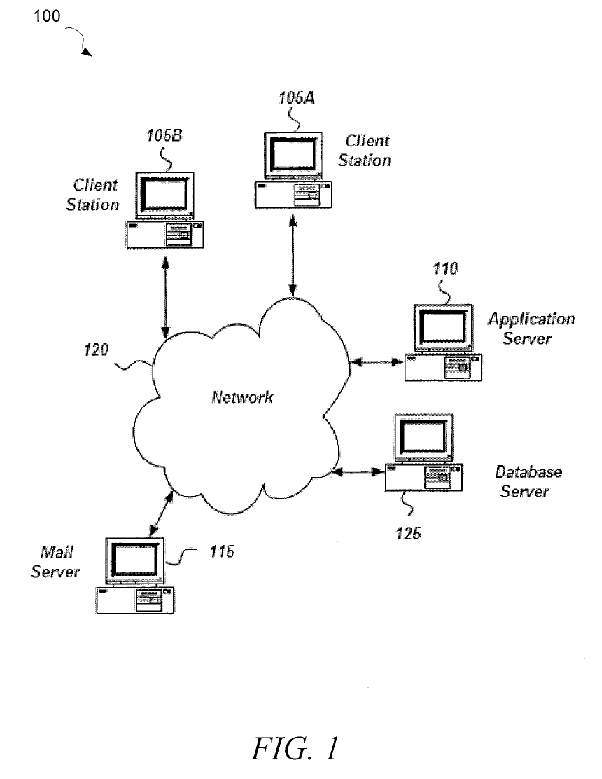

FIG. 1 is an example network diagram that may be used, in accordance with some example embodiments. Network diagram 100 may include network 120 and various devices connected to the network 120. The network 120 may include one or more local area networks (“LANs”) and/or wide area networks (“WAN”), such as the Internet. The various devices connected to the network 120 may include client stations 105A and 105B, application server 110, mail server 115, and database server 125. Although not shown, other devices, clients, servers, processes, and the like may also be connected to the network 120. Network connections within, to, and from the network 120 may be carried out using one or more of twisted pair, fiber optics, coaxial cable, analog telephone lines, fall or fractional dedicated digital lines including T1, T2, T3, and T4, Integrated Services Digital Networks (ISDNs), Digital Subscriber Lines (DSLs), wireless links, and the like. Furthermore, the network 120 may include one or more sub-networks located in the same geographical area or in various geographical areas.

The client stations 105A-105B, the application server 110, the mail server 115 and the database server 125 may communicate with one another using the network 120. For some example embodiments, these devices may enable members of a community to interact with one another.

Each of the application server 110, the mail server 115, and the database server 125 may include one or more processors to execute instructions, random access memory (RAM) to store instructions and information, storage device to provide persistent storage for the instructions and the information, and network interface to enable connection to the network 120. Various communication protocols may be used for communication via the network 120. One example protocol is transmission control protocol/Internet protocol (TCP/IP) and user datagram protocol/Internet protocol (UDP/IP).

### Community

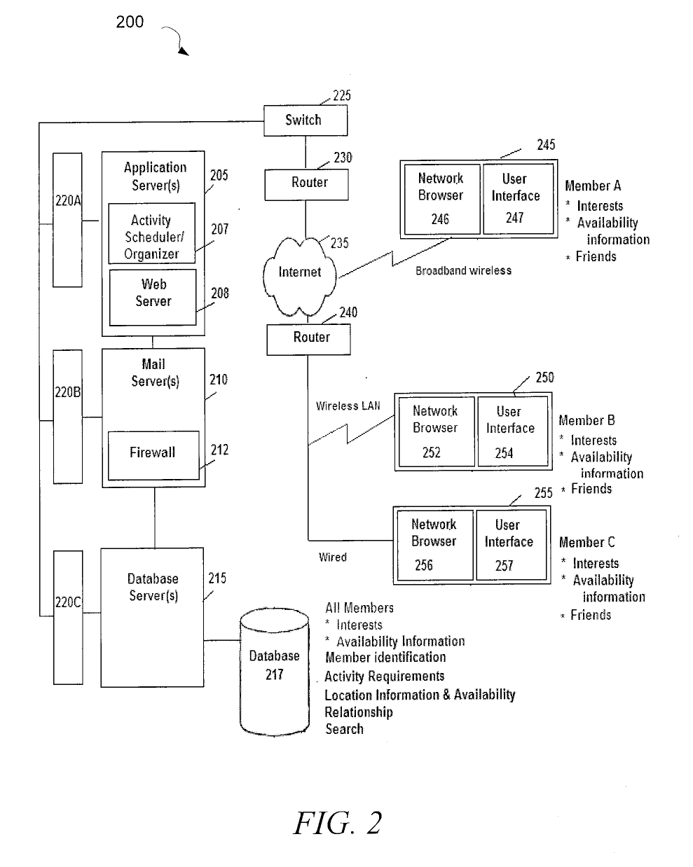

FIG. 2 is another example of a network that may be used to implement a community, in accordance with some example embodiments. Network 200 may include one or more application server(s) 205, one or more mail server(s) 210, and one or more database server(s) 215.

The application server 205 may include an activity organizing application 207 and a web server 208. As will be described, the activity organizing application 207 may be referred to as a “brain” of the network 200 because it may collect information from the members and from various other sources to intelligently schedule and suggest activities that the members may want to participate. For some example embodiments, the activity organizing application 207 may suggest activities to the members of the network 200 based on their interest information, their availability information, the requirements of the activities, the availability information of their friends, etc. The activity organizing application 207 may receive the interest information and the availability information from the members.

The web server 208 may be used to enable communicating with the client stations 245, 250, and 255 using a web browser. The web server 208 may provide interfaces in the forms of web pages. For some example embodiments, the web server 208 may provide interfaces to allow the members of the network 200 to enter their interest information, their availability information, their friends' information, etc. The web server 208 may also provide interfaces that enable the activity organizing application 207 to suggest activities to the members.

The mail server 210 may be coupled to the application server 205 and may be used to store and distribute mails associated with the members of the network 200. The mail server 210 may be associated with a firewall 212 to protect the privacy of the information of the members and to prevent unauthorized access by others (e.g., hackers). Functionalities of the firewall 212 may be integrated in the mail server 210, or it may be integrated into a separate device external to the mail server 210. The mail server 210 may also include software that detect and block out viruses.

The database server 215 may be coupled to the application server 205. The database server 215 may include database 217 to store information associated with the members and any other information that may be necessary to operate the network 200. For example, the database 217 may store the members' interest information, the availability information, the member identification information, the activity requirements, the location information, etc. in various database tables. The database server 215 may include one or more of a database management system (DBMS), an object-oriented database management system (ODBMS), a relational database management system (e.g. DB2, ACCESS etc.), a file system, or any other data storage system currently available or will be available. A database query language such as, for example, Structured Query Language (SQL) may be used to search, delete, insert, and alter the tables in the database 217. The database query language may also be used to form relationships of various information (e.g., tables) stored in the database 217.

Each of the application server 205, the mail server 210, and the database server 215 may be coupled to a network interface 220A, 220B and 220C respectively. These network interfaces may be coupled to a switch 225 and a router 230 to connect to network 235 (e.g., Internet). It may be noted that even though the application server 205, the mail server 210 and the database server 215 are illustrated as separate devices, in certain situations, functionalities of two or more of these servers may be combined.

The members may connect to the network 200 using any one of the client stations 245, 250, and 255. Router 240 may be used to connect to the network 235. A client station may be connected to the network 235 using wired or wireless connection. When using the wireless connection, a client station may be a mobile telephone, a Personal Digital Assistant (PDA) smart phone, any portable devices that may include a Wireless Fidelity (Wi-Fi) modem, a broadband modem, or any integrated devices that may combine one or more of the preceding devices and the like. In the current example, the client stations 245 may connect to the network 235 using wireless broadband, and the client station 250 may connect using wireless local area network (LAN). The client station 255 may be connected using a wired connection (e.g., Ethernet connection). A member of the network 200 may use one of these client stations 245, 250, and 255 to provide the interest information, the availability information, etc.

Each of the client stations 245, 250 and 255 may include a network browser application 246, 252, and 256 respectively. The browser application may be configured to send, receive and display graphics, text, multimedia, and the like. Various web-based languages and protocols may be used. These may include, for example, Standard Generalized Markup Language (SMGL), HyperText Markup Language (HTML), wireless application protocol (WAP), Wireless Markup Language (WML), WMLScript, JavaScript, etc. When connected to the network 200, each of the client stations 245, 250 and 255 may be presented with user interfaces 247, 254, and 257 respectively. As described above, the user interfaces 247, 254 and 257 may be presented by the application server 205.

For some example embodiments, each of the client stations 245, 250, and 255 may be further configured to receive a message from the another computing device employing another mechanism, including, but not limited to email, Short Message Service (SMS), Multimedia Message Service (MMS), instant messaging (IM), Internet relay chat (IRC), etc. It may be noted that although the description may refer to a community or communities of members, the techniques described herein may also be used in other environments.

### Data Structure

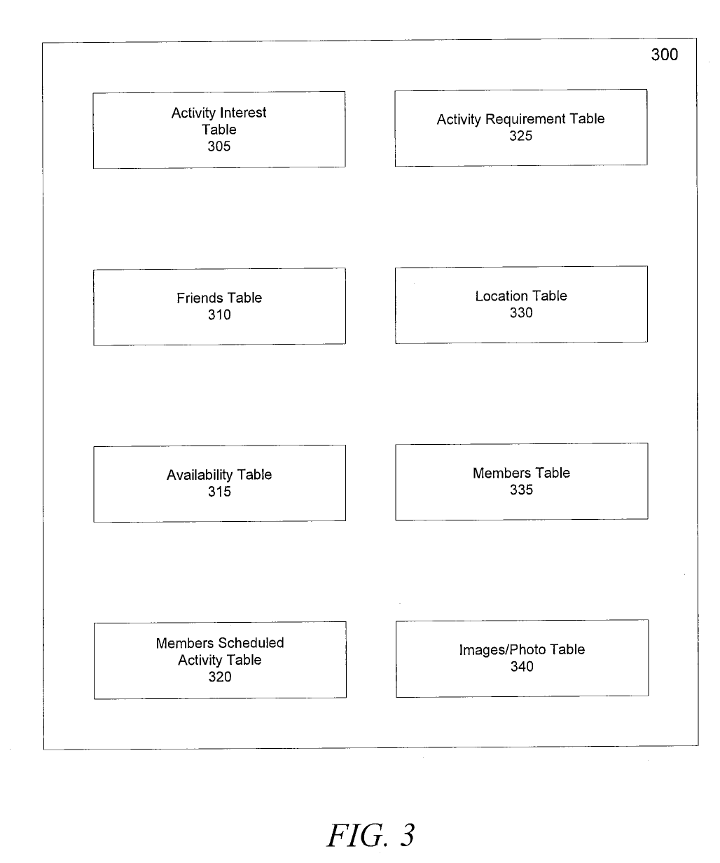

FIG. 3 is a block diagram that illustrates examples of various database tables that may be used, in accordance to some example embodiments. Table 300 may be maintained in the databases 217 and may be utilized by and may support the network 200 (illustrated in FIG. 2).

The table 300 may include a member table 335 which may include information about all registered members of the network 200. There may be a record for each registered member. Each record may include member identification information, an email address and other pertinent information associated with the member. For some example embodiments, a member may act as an initiator or organizer of an activity in the network 200.

The table 300 may also include an activity requirement table 325 which may include information about various activities that may have been specified by an administrator of the network 200 or provided by the members of the network 200. The activity requirement table 325 may include information about number of required participants for an activity to be organized. The activity requirement table 325 may also include other factors that may be required. For example, these factors may include equipment information, information about the environment (e.g., day time, dry), etc.

The table 300 may include location table 330 which may include addresses of various locations where one or more of the activities may occur. The location table 330 may include information related to map and direction, reservation contact, usage costs, location availability, etc.

The table 300 may also include images or photo table 340 which may include graphics information related to one or more of the members, the activities, the location, etc. Other graphics information may also be stored. Video and/or audio information may also be stored in this table or similar tables.

The table 300 may also include interest table 305 which may include information related to various activities that a particular member may be interested in participating. The information in the interest table 305 may be used to determine whether to invite a member when certain activities are organized.

The tables 300 may include friends table 310 which may include information related to the friends of a particular member. These friends may also be members of the network 200. The information may include, for example, the identification information of the friends.

The tables 300 may also include availability table 315 which may include information related to a member's schedule. The schedule may include time blocks that the member may be busy and time blocks that the member may be free.

The table 300 may include scheduled activity table 320 which may include information related to one or more activities that a particular member is scheduled to participate in. As will be described, these activities may have been manually organized by a member of the network 200, or it may be automatically organized by the network 200. Although not shown, the table 300 may also include other tables that may be necessary by the activity organizing application to suggest activities to its members. It may be noted that the tables are described as examples, and some tables may be combined to include similar information.

### Application Modules

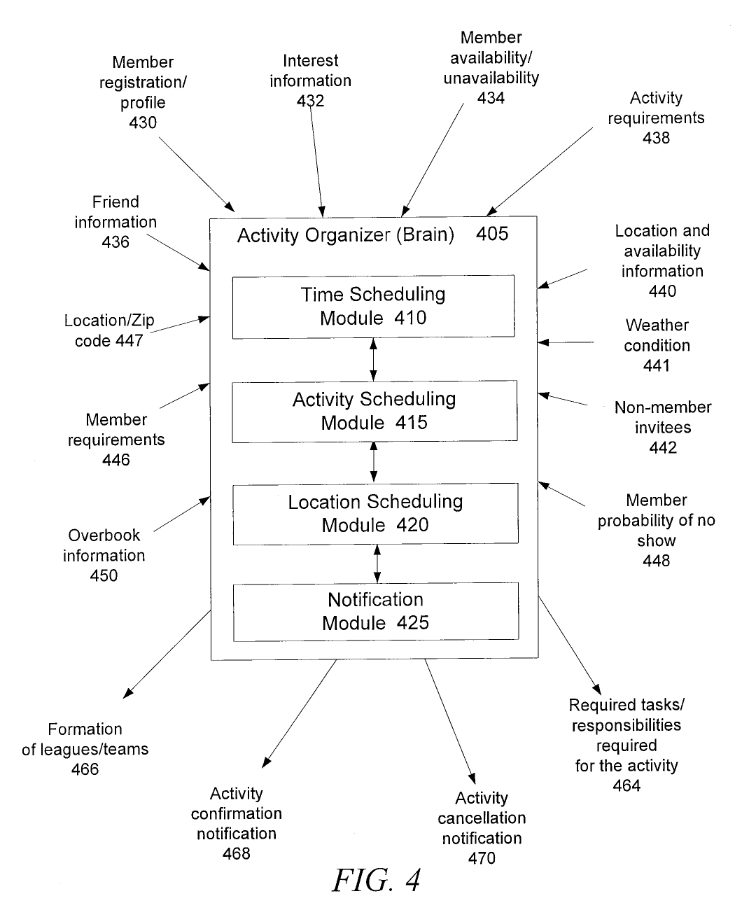

FIG. 4 is a block diagram that illustrates an example of the various modules that may be included in the activity organizing application, in accordance with some example embodiments. Activity organizing application 405 may include various modules to enable it to organize and suggest activities to the members of the network 200. Some of these modules may include time scheduling module 410, activity scheduling module 415, location scheduling module 420 and notification module 425.

The activity organizing application 405 may receive member registration information 430, activity requirements information 438, location information and location availability information 440, and location code (e.g., zip code) 447 from the members or from the administrator of the network 200. This information may be used by one or more of the time scheduling module 410, the activity scheduling module 415, the location scheduling module 420, and the notification module 425. It may be noted that the member registration information 430 may include a location code which may correspond to an area where the member may reside within or nearby.

The time scheduling module 410 may receive member availability and unavailability information 434 from the individual members and may use that information to determine available time blocks for all of the members located in a certain geographical area. The time scheduling module 410 may also determine the time blocks that are open for the members that are associated with various groups where the members of the group may share the same interest. For example, the members of the group may belong to the same church and they may all like to visit the elderly in convalescent homes. Members who are friends with one another may belong to the same group, and some members may prefer to participate in activities when one or more of their friends also participate.

The activity scheduling module 415 may receive interest information 432 and friend information 436 and may use that information to determine an activity that a member and the member's friends may be interested in participating. For some example embodiments, only those members who share the same interest in a particular activity may be invited to participate in that activity. For some example embodiments, only those members who have the same open time blocks may be invited to participate in that activity. For some other example embodiments, only those members who reside or may be present within or near a certain location code may be invited to participate in an activity.

For some example embodiments, the activity scheduling module 415 may also take into consideration member requirement information 446 in organizing the activities. The member requirement information 446 may include member's personal preferences. For example, a member may prefer to participate in a particular activity only if certain member friends also participate. Similarly, a member may prefer not to participate in an activity if a certain other member is participating. As another example, a member may prefer to participate in an activity only if the activity can be organized on a weekend.

For some example embodiments, attendance at a scheduled activity may be recorded. For some example embodiments, the activity scheduling module 415 may consider a member's past records of not showing up for scheduled activities in determining whether there are enough participants to schedule an activity. For example, if an invited member typically shows up for less than 50% of the past scheduled activities, the activity scheduling module 420 may invite more members than a number of required participants to make up for the potential no-shows. Similarly, the activity scheduling module 415 may also take into consideration overbook information 450 to invite more members than a number of required participants. For example, some members may become tired or injured during a football game activity and therefore substitute members may be needed. Different overbook information 450 may be applied to different activities. For example, to organize an activity such as going to a concert, it may not be necessary to use the overbook information 450.

For some example embodiments, the activity scheduling module 415 may also consider weather condition information 441 as a factor in scheduling an activity. The weather condition information 441 may be provided by a weather service provider. For example, the weather condition information 441 may be received via a really simple syndication (RSS) feed such as the one provided by the weather channel. Other techniques of receiving the weather condition information 441 may also be used. For some example embodiments, the activity scheduling module 415 may not schedule an outdoor activity when the weather condition information 441 indicates that the weather (e.g., storm, heavy rain, etc.) may not be appropriate for the outdoor activity.

For some example embodiments, the activity scheduling module 415 may also consider sunrise and sunset times in scheduling activities. This may be because the day light hours may vary at different times of the year. The activity scheduling module 415 may not schedule an outdoor activity after sunset or before sunrise if the activity requires daylight. Similarly, the activity scheduling module 415 may not schedule an outdoor activity before sunset or before sunrise if the activity requires that there is no daylight. The weather condition information 441 may be considered either for automated activity scheduling or for manual activity scheduling.

For some example embodiments, after the open time blocks and the interest are matched, the activity organizing application 405 may need to determine a location for the activity. This may be performed by the location scheduling module 420 which may use the location code information 447 (e.g., zip codes). The location scheduling module 420 may identify a location that is associated with a location code or within a certain distance from the location code. A point at or near a center of the location code may be used as a reference point to determine distance. The location code associated with an area may be the same location code where the member and the invited members may reside according to their member registration or profile 430.

For some example embodiments, it may not be necessary to determine a location when the activity can occur online.

For some example embodiments, when an activity is manually created by a member, that member may also have an option to invite non-members to participate in the activity. The non-member may not be associated with any interest information 432, availability information 434 or registration information 430. In these situations, it may be assumed that the non-members may be interested in the activity and may be available to participate in the activity during the time block suggested by the member.

For some example embodiments, when an activity is automatically organized by the activity organizing application 405, notifications may be sent to the invited members by the notification module 425. For some example embodiments, when an activity is manually created by a member, notifications may be sent by the notification module 425 to the member, the invited members and the invited non-members when applicable. The notifications may include information about the suggested activity and the suggested location where the activity may occur. For some example embodiments, the notification may also include information about the invited members and non-members when applicable.

For some example embodiments, the invited members and, when applicable, the invited non-members may reply to the notifications. When the notification includes a suggestion for an activity, the reply may include a decline to the invitation or an acceptance of the invitation. For some example embodiments, the reply may include a message similar to positive attendance, negative attendance, or possible attendance. In certain situations, there may not be a reply.

When all replies are received, the activity organizing application 405 may determine whether the suggested activity may occur. If the number of positive attendance indicates that the activity can occur, an activity confirmation notification 468 may be sent. For some example embodiments, the activity organizing application 405 may also include in the activity confirmation notifications required tasks and responsibilities information 464.

When there are not sufficient positive attendance replies, or when there are issues with the suggested location, an activity cancellation notification 470 may be sent. For some example embodiments, alternative location may be suggested if an original suggested location is objected to. It may be noted that the activity organizing application 405 may use the information it receives from the members to perform other operations. For example, the activity organizing application 405 may group members into leagues or teams 466 based on their interests. In addition, the activity organizing application 405 may collect skill information from the members and may organize the teams according to their skill levels.

### Limited Functionalities to Non-Members

The network 200 may provide non-members limited functionalities in organizing activities. For some example embodiments, the non-members may be allowed to have a limited view of different automated activities happening in their area. For example, the non-members may be able to enter a zip code of an area to find out activities that have been organized. The non-members may only be able to see the activity titles and the number of players signed up for the activities. For some example embodiments, information such as location, time, participants' comments and other features will be blocked and not be viewable by the non-members. When the non-member tries to access any of these blocked features, a message may be displayed to request the non-member to register. For example, the message may be “You may view these items if you agree to the terms of use” or “registration is required” or something similar.

For some example embodiments, the non-members may also have some limited ability to create activities. When a nonmember wants to create an activity, the non-member may be able to go through some of the operations (e.g., activity information, invitee information, etc.) but may not be able to have the activity organizing application 405 provide any recommendations (e.g., time, location, etc.) For some example embodiments, when the non-member submits the activity information, that information may be saved, and the non-member may receive a request to register or sign up with the network 200. The request may be sent to an email address provided by the non-member. Once the non-member registers, the invitation for the activity may be sent to the invitees by the network 200.

### Examples of Organizing Activities

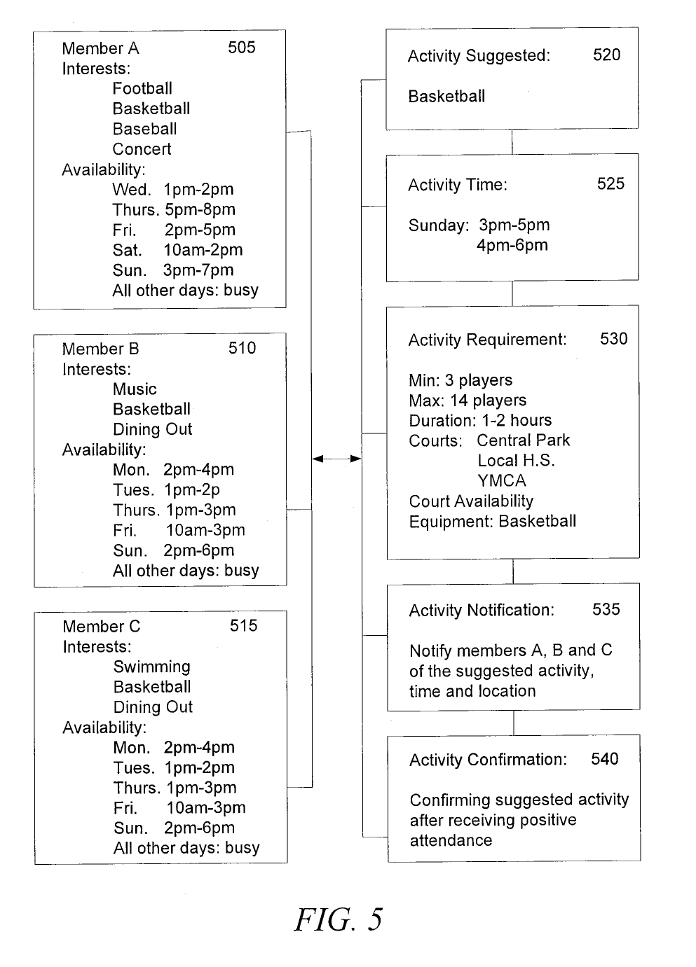

FIG. 5 is a block diagram that illustrates some specific examples related to automatically organizing an activity for the members of a network, in accordance with some example embodiments. Blocks 505, 510 and 515 in the left column include example information related to members A, B and C. As illustrated, each of the members A, B and C may have many interests with some common interests (e.g., basketball). Because they all like to play basketball, the activity organizing application 405 may suggest the basketball activity (block 520).

Block 530 illustrates example activity requirements and location information to organize a basketball activity. Since the duration of the activity is between one to two hours, the activity organizing application 405 may suggest a basketball game from 3 pm to 5 pm or from 4 pm to 6 pm on Sunday (block 525). No other time blocks are suggested because one or more of the members A, B, and C may be busy. The members A, B, and C may be notified about the suggested basketball activity (block 535), and a confirmation may be sent if all three members vote and agree to the suggested basketball activity (block 540). When the basketball activity is confirmed, the activity organizing application 405 may update the schedules of the members A, B, and C to reflect that the basketball activity is scheduled from 3 pm to 5 pm on Sunday, for example. For some example embodiments, the automatic organization of an activity may involve only members of the network, and may not include any non-members. It may be noted that the activity organizing application 405 may be capable of automatically organizing many simultaneous activities for many different groups of members in similar or different locations.

### Default Initial Values

For some example embodiments, a set of default information may be set for a new member after the new member signs up or registers with the network 200. The default information may have certain time blocks (e.g., between 10 pm to 8 am) of the member's schedule identified as sleep time blocks. The default information may also have certain time blocks identified for other purposes depending on the information provided by the new member during the registration process. For example, if the new member is a student, then the default information may include time blocks during the day identified as being busy going to school. If the new member is employed full time during the day, then the default information may include time blocks during the day identified as being busy working. The new member may have the option to modify the default information at any time.

For some example embodiments, after the new member is registered, the new member may be directed to a web page to provide availability information and interest information. The new member may then be able to select activities (e.g., by clicking on a selection tab) at an activity selection page. For some example embodiments, the new member may be presented with a list of major activity categories. For example, the general activity categories may include “Games”, “Music/Arts”, “Party”, “Trips”, and so on.

When the member decides on one of the major activity categories (e.g., by clicking on a selection tab) the member may have the ability to select specific interests under that major activity category. Some major activity categories may include one or more activity subcategories. For example, under the general activity category “Games”, there may be an activity subcategory of “Card games”, “Team Games”, etc.

There may be one or more interests under a major activity category or under an activity subcategory for the member to select. For some example embodiments, a member may be able to search for an interest (e.g., using a search box). For example, if the member enjoys playing poker, the member can enter “Poker” in a search field.

### User Interface

The activity organizing application 405 may organize activities based on specific input provided by the member (e.g., manually creating an activity) or based on general input provided by the member (e.g., automatically creating an activity). The following interfaces illustrate examples of some of the different situations that the members of the network 200 may use the activity organizing application 405 to organize activities. The interfaces may be presented using a browser or web-based software.

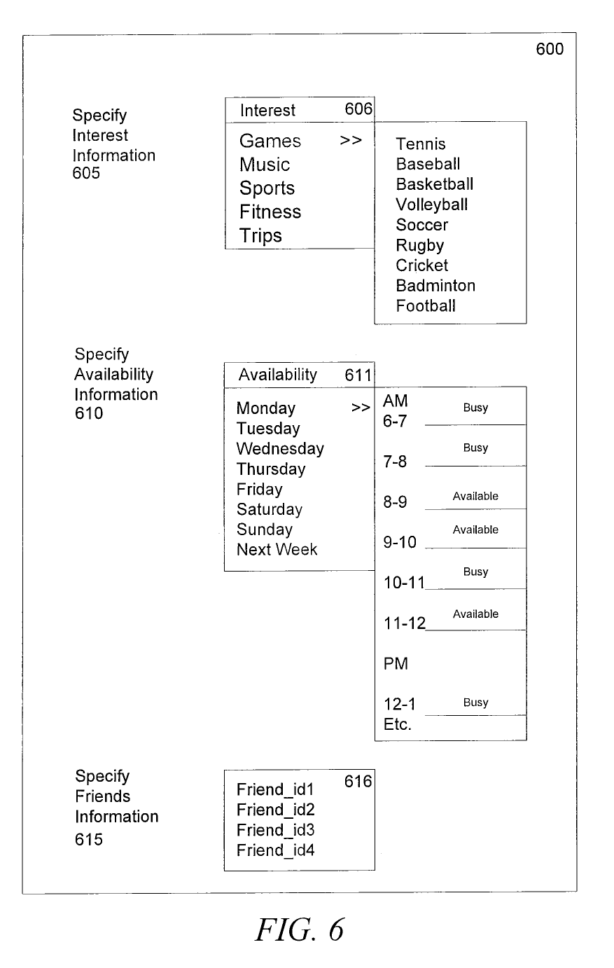

FIG. 6 illustrates an example interface that may be used to provide interested activity and availability information, in accordance with some example embodiments. A member of the network 200 may use an interface to provide interest information and availability information. Interface 600 in the current example may include an interest information area 605, availability information area 610, and friend information area 615. The interface 600 may be part of an interface used to create a member profile for a new member. The interest information area 605 may include a list of interest 606 to enable the member to select one or more interests. The availability information area 610 may include a list of days of the week 611 to enable a member to select a day and to specify busy and non-busy or free time blocks. The friend information area 615 may include a text box 616 to enable a member to enter identification of the friends. The information entered in the different areas of the interface 600 may be stored in the database 217. The interest information, the availability information and the friend information may be updated by the member at any times.

### Activity Creation Using Specific Date and Time Information

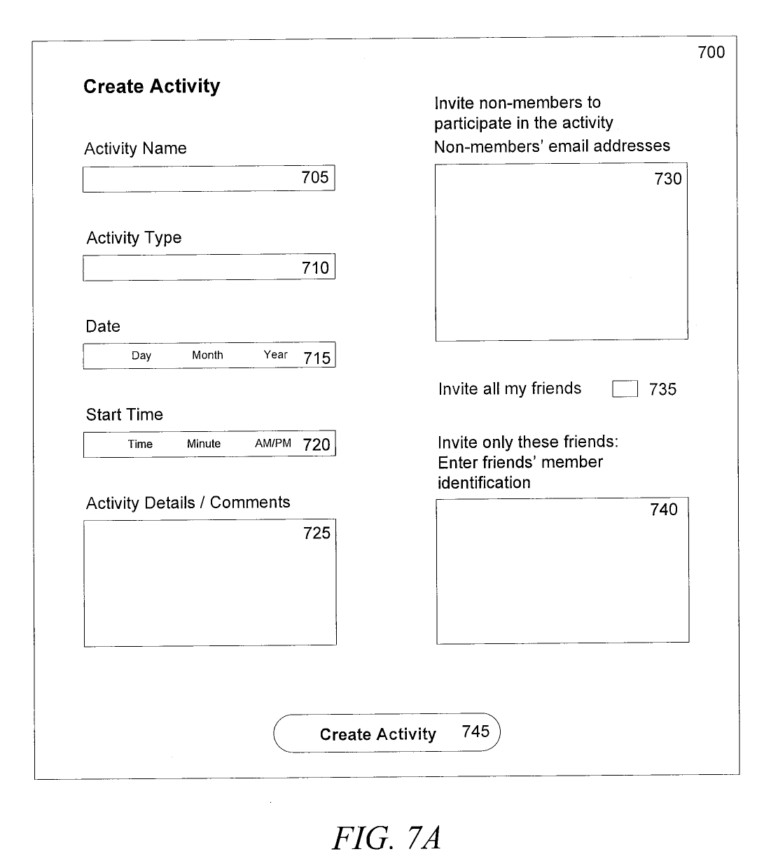

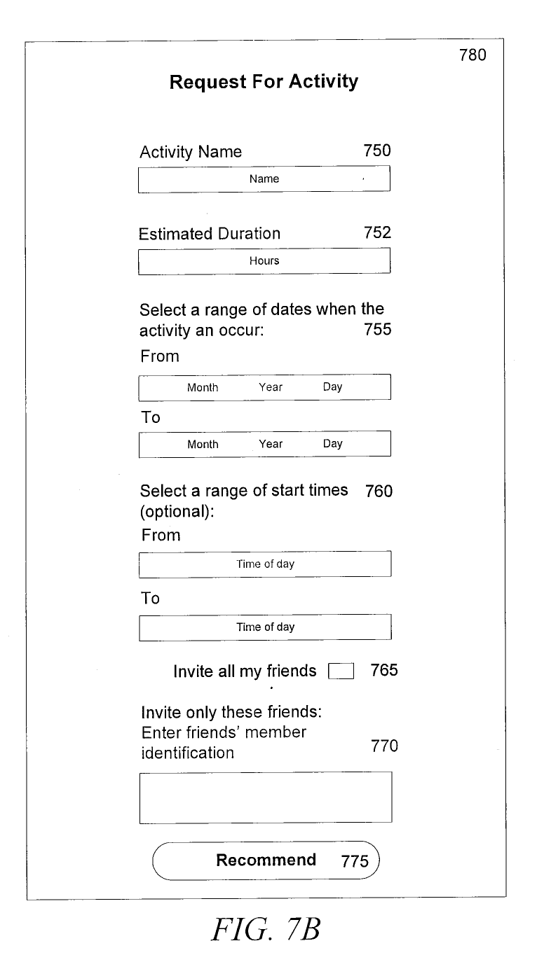

FIG. 7A illustrates an example interface that may be used to create activities, in accordance with some example embodiments. A member may use interface 700 to manually create an activity by specifying detail information about the date, the time, the invitees, and so on. For example, the information about the activity may be entered using activity name input area 705 and activity type input area 710. It may be noted that the member may be presented with a list of predetermined activities to select for the activity type input area 710. For some example embodiments, the member may also enter a new activity that is not in the list of predetermined activities. It may also be noted that the list of predetermined activities may continue to grow based on the new activities added or suggested by the members.

Date and time information may be entered using the date input area 715 and the time input area 720. There may be comments input area 725, member invite input area 735 and 740, and non-member invite input area 730. The member invite input area 735 may be used as a quick method to invite all of the friends who are also members. When only some of these friends are invited, their member identification information may be entered into the input area 740. It may be noted that the member identification information may be a unique for each member. It may also be noted that the member identification information may be associated with an alias. For some example embodiments, the alias may be used in place of the member identification information. The non-member invite input area 730 may be used only when there are non-member friends to be invited. When the create activity option 745 is selected, the information entered in the input areas described in this section may be sent to the activity organizing application 405 and notifications may be sent to the member invitees and the non-member invitees when applicable. When the activity is confirmed, the activity organizing application 405 may store the information related to the activity with the schedules of the member invitees. It may be noted that an activity created by a member may be edited by that member after the activity is confirmed. Editing the activity may include inviting more people to participate, changing the date and/or time, and so on. Although not shown, the interface 700 may include other information presented by the activity organizing application 405.

### Activity Creation Using Date Range and Time Range Information

FIG. 7B illustrates an example interface that may be used to request an activity to be suggested, in accordance with some example embodiments. Interface 780 may be used by a member to manually enter information that may be used by the activity organizing application 405 to suggest an activity. In the current example, information about the activity and its duration may be entered using activity name input area 750 and estimated duration input area 752.

Instead of specifying a specific date and a specific time for the activity as in the example illustrated in FIG. 7A, the member may specify a range of dates and times using the date input area 755 and time input area 760. This may provide more flexibility for the activity organizing application 405 to suggest a date and time that is more likely to fit the schedules of the invitees specified in one of the invitee input areas 765 and 770. The use of the input areas 765 and 770 may be similar to the use of the input areas 735 and 740 illustrated in FIG. 7A, respectively. Although not shown, there may also be an invitee input area for non-members. The activity organizing application 405 may only have access to the interested activity information and availability information of the invitees who are members of the network 200. The non-member invitees may only have the option to accept or to decline the activity and the date and time suggested by the activity organizing application 405. When the recommend option 775 is selected, the information entered in the input areas described in this section may be sent to the activity organizing application 405 and notifications may be sent to the member invitees and the non-member invitees when applicable. When the activity is confirmed, the activity organizing application 405 may store the information related to the activity with the schedules of the member invitees. It may be noted that the activity organizing application 405 may be capable of helping many members and/or groups of members of the network 200 organizing many simultaneous activities in similar or different areas.

### Automatic Activity Creation

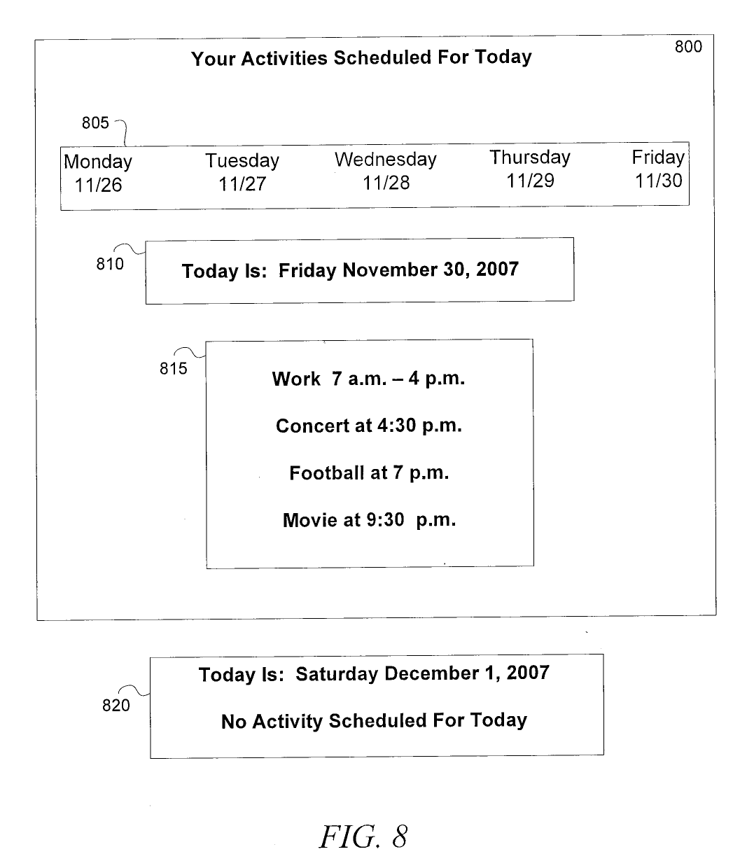

FIG. 8 illustrates an example interface that may be used by the activity organizing application to present one or more suggested activities to a member, in accordance with some example embodiments. Interface 800 may be presented to a member when the member signs in to the network 200. The interface 800 may include information related to a calendar and may enable the member to select a daily view, a weekly view or a monthly view. The member may also have the option to change date (e.g., day, week, month, or year) to access scheduling information associated with a particular date. The current example illustrates a daily view associated with a particular week illustrated in block 805. Information related to a current day is illustrated in block 810, and activities scheduled for the day is illustrated in block 815. It may be noted that these activities may include activities created manually by a member and/or activities created automatically by the activity organizing application 405. Block 820 illustrates an example of information that may be displayed in the interface 800 when there is no activity scheduled for the day.

For some example embodiments, the activity organizing application may include options to enable the members to be reminded about up-coming confirmed activities, pending activities to be confirmed, change in previously confirmed activities, and so on. The members may be reminded by any communicating technique including, but not limited to emails, SMS, MMS, IM, IRC, etc. Although not shown, the interface 800 may include other information presented by the activity organizing application 405.

### Process

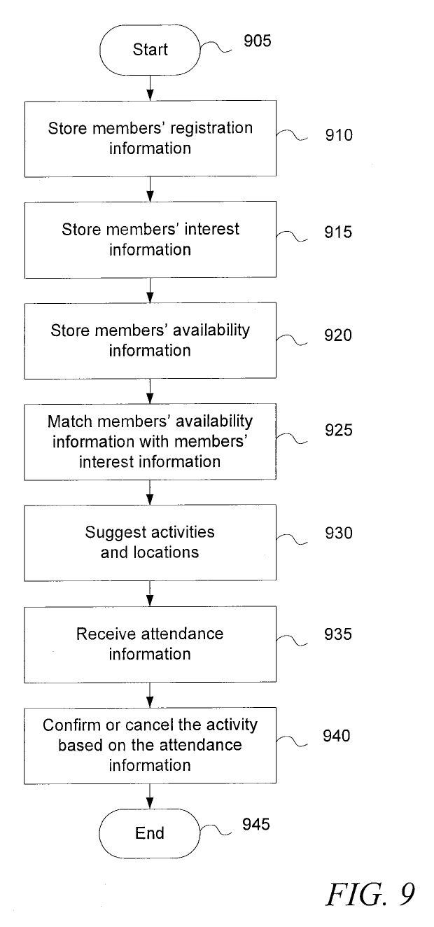

FIG. 9 is an example flow diagram that illustrates a process that may be performed by the activity organizing application to automatically create an activity, in accordance with some example embodiments. The process may include some example operations from initial member registration to activity notification. The sequence of some of the operations may be modified and therefore should not be viewed as restrictive. Other operations not described may be understood by one skilled in the art.

The process may start at block 905. At block 910, member registration information may be received and stored. The member registration information may include member identification information, location code, and the like. At block 915, the member's interest information may be stored. At block 920, the member's availability information may be stored. For example, the interest information and the availability information may be provided by the member using the interface 600. The information may be stored in the database 217 illustrated in FIG. 2.

At block 925, the activity organizing application may search for the members in the same area and determine if they have similar interests. The search may be based on all members having the same location code according to their member registration or profiles. It may also be based on members who are in the same circle of friends. The activity organizing application may further search their schedules to determine if they may be available to participate in the activities. When there are enough members who share the same interest information, the activity organizing application may send out notification to suggest the activity, as shown in block 930. The activity organizing application may also suggest a location.

At block 935, the members may provide information to indicate whether they can attend or participate in the suggested activity. This information may be received by the activity organizing application. Based on the information, the activity organizing application may send out a follow-up confirmation or cancellation, as shown in block 940. The process may end at block 945.

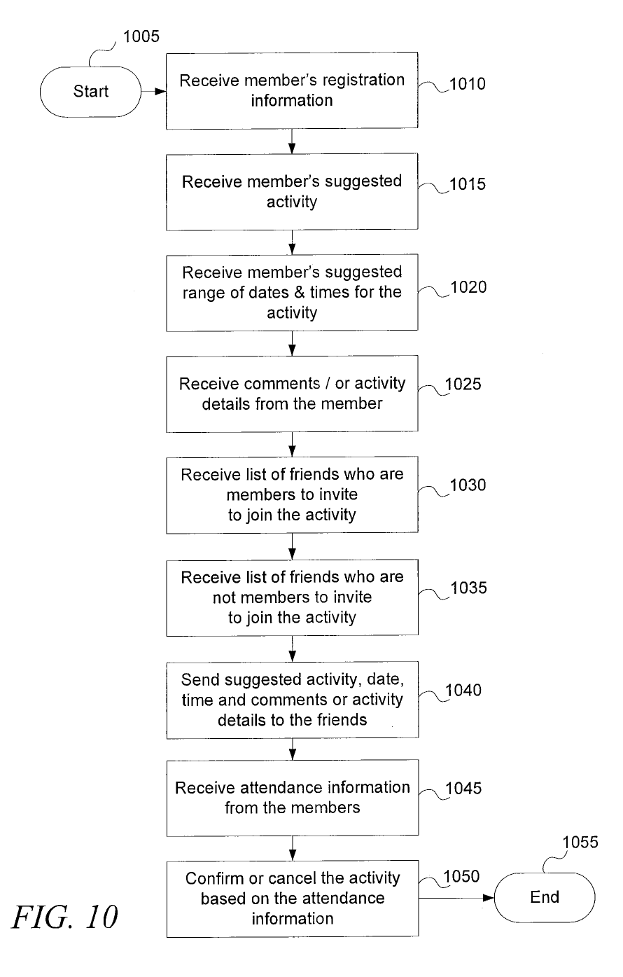

FIG. 10 is an example flow diagram that illustrates a process that may be performed by the activity organizing application to organize an activity created by a member, in accordance with some example embodiments. The process may include some example operations from initial member registration to activity notification. The sequence of some of the operations may be modified and therefore should not be viewed as restrictive. Other operations not described may be understood by one skilled in the art.

The process may start at block 1005. At block 1010, member registration information may be received and stored. At block 1015, a member may suggest an activity to be organized. This information may be received by the activity organizing application. At block 1020, the date and time range information may be received from the member. At block 1025, other information related to the activity suggested by the member may be received. At blocks 1030 and 1035, information about member-invitees and non-member invitees may be received. At block 1040, the activity organizing application may process the information received from the member and may notify the invitees about the suggested activity.

At block 1045, the members may provide information to indicate whether they can attend or participate in the suggested activity. This information may be received by the activity organizing application. Based on the information, the activity organizing application may send out a follow-up confirmation or cancellation, as shown in block 1050. The process may end at block 1055.

The operations described in the example flow diagrams of FIG. 9 and FIG. 10 maybe implemented in software and may be written using a combination of one or more technologies that include, for example, Dynamic Hyper Text Markup Language (DHTML), Asynchronous JavaScript and XML (AJAX), FLASH™, HTML, Flex, Active X, Java applet technologies. Other technologies may also be used.

### Computer System

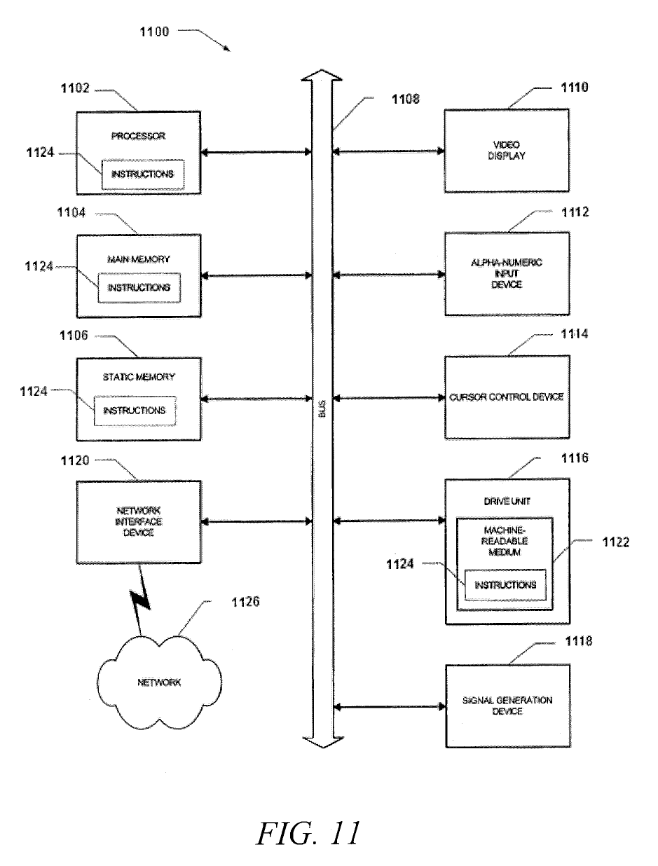

FIG. 11 illustrates an example diagram of a representation of a machine in the example form of a computer system that may be used, in accordance with some example embodiments. Set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

In the current example, computer system 1100 may include a processor 1102 (e.g., a central processing unit (CPU), a graphics processing unit (GPU), or both), a main memory 1104 and a static memory 1106, which communicate with each other via a bus 1108. The computer system 1100 may further include a video display unit 1110 (e.g., liquid crystals display (LCD) or a cathode ray tube (CRT)). The computer system 1100 also includes an input device 1112 (e.g., a keyboard), a cursor control device 1114 (e.g., a mouse), a disk drive unit 1116, a signal generation device 1118 (e.g., a speaker) and a network interface device 1120.

The disk drive unit 1116 includes a machine-readable medium 1122 on which is stored one or more sets of instructions (e.g., software 1124) embodying any one or more of the methodologies or functions described herein. The instructions 1124 may also reside, completely or at least partially, within the main memory 1104, the static memory 1106, and/or within the processor 1102 during execution thereof by the computer system 1100. The main memory 1104 and the processor 1102 also may constitute machine-readable media.

The instructions 1124 may further be transmitted or received over a network 1126 via the network interface device 1120. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In example embodiments, a computer system (e.g., a standalone, client or server computer system) configured by an application may constitute a “module” that is configured and operates to perform certain operations as described herein below. In other embodiments, the “module” may be implemented mechanically or electronically. For example, a module may comprise dedicated circuitry or logic that is permanently configured (e.g., within a special-purpose processor) to perform certain operations. A module may also comprise programmable logic or circuitry (e.g., as encompassed within a general-purpose processor or other programmable processor) that is temporarily configured by software to perform certain operations. It will be appreciated that the decision to implement a module mechanically, in the dedicated and permanently configured circuitry, or in temporarily configured circuitry (e.g. configured by software) may be driven by cost and time considerations. Accordingly, the term “module” should be understood to encompass a tangible entity, be that an entity that is physically constructed, permanently configured (e.g., hardwired) or temporarily configured (e.g., programmed) to operate in a certain manner and/or to perform certain operations described herein.

While the machine-readable medium 1122 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present description. The term “machine-readable medium” shall accordingly be taken to include, but not be limited to, solid-state memories, optical and magnetic media, and carrier wave signals.

As noted, the software may be transmitted over a network using a transmission medium. The term “transmission medium” shall be taken to include any medium that is capable of storing, encoding or carrying instructions for transmission to and execution by the machine, and includes digital or analog communications signal or other intangible medium to facilitate transmission and communication of such software.

Although the invention has been described in terms of communication between servers, client stations, network devices, members, and the like, the embodiments of the invention is not so limited. For example, the communication may be between virtually any resource, including but not limited to multiple members, multiple servers, and any other network devices, without departing from the scope of the disclosure.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure.

It may be appreciated that FIGS. 1-11 are merely representational and may not be drawn to scale. Certain proportions thereof may be exaggerated, while others may be minimized. Accordingly, the specification and drawings are to be regarded in an illustrative rather than a restrictive sense.

The Abstract is provided to comply with 37 C.F.R. §1.74(b) to allow the reader to quickly ascertain the nature and gist of the technical disclosure. The Abstract is submitted with the understanding that it will not be used to interpret or limit the scope or meaning of the claims.

In the foregoing description, various features are grouped together in a single embodiment for the purpose of streamlining the disclosure. This method of disclosure is not to be interpreted as reflecting an intention that the claimed embodiments have more features than are expressly recited in each claim. Thus the following claims are hereby incorporated into the description, with each claim standing on its own as a separate embodiment.

Thus, a method and system to organize and suggest activities to members of a network have been described. Although embodiments have been described with reference to specific example embodiments, it will be evident that various modifications and changes may be made to these embodiments without departing from the broader spirit and scope of embodiments as expressed in the subjoined claims.

What is claimed is:

1. A method of organizing activities for members of a network, comprising:
identifying a group of members of a network;
determining an activity for two or more of the members of the group, wherein the activity
is determined according to interest information provided by the two or more members;
scheduling the activity according to availability information provided by the two or more
members; and
suggesting the activity to the two or more members.

2. The method of claim 1, wherein said scheduling the activity comprises determining a date and time when the activity is to occur using the availability information provided by the two or more members.

3. The method of claim 2, wherein said scheduling the activity further comprises determining a location where the activity is to occur.

4. The method of claim 3, wherein the location is determined based on location information associated with the two or more members.

5. The method of claim 4, further comprising:
responsive to receiving attendance information from the two or more members, sending activity confirmation information to the two or more members if the attendance information is positive; otherwise, sending activity cancellation information to the two or more members.

6. The method of claim 5, further comprising:
if the attendance information is positive, updating the availability information of the two or more members to reflect their attendance information.

7. The method of claim 6, wherein the attendance information is positive when at least a minimum number of members will participate in the activity.

8. The method of claim 4, wherein each member of the group is associated with a member profile, and wherein the member profile includes the interest information, the availability information, and the location information.

9. The method of claim 8, wherein the member profile further includes information relating to friends who are also members of the network.

10. The method of claim 9, wherein the network is configured to schedule multiple activities for multiple groups of members in multiple locations.

11. A machine-readable medium comprising instructions, which when implemented by one or more processors perform the operations as claimed in claim 1.

12. A method of organizing activities for members of a network, comprising:
receiving from a first member of the network information relating to an activity to be organized;
receiving from the first member information relating to date and time when the activity is to occur;
receiving from the first member information about a second member to invite to participate in the activity; and
suggesting the activity and the date and the time when the activity is to occur to the second member.

13. The method of claim 12, further comprising:
before said suggesting, verifying availability information of the second member to determine if the second member is available on said date and time.

14. The method of claim 12, wherein the information relating to the date and the time when the activity is to occur comprises a date range and time range.

15. The method of claim 12, further comprising:
receiving from the first member information about a non-member of the network to invite to participate in the activity; and
suggesting the activity and the date and the time when the activity is to occur to the non-member.

16. The method of claim 12, further comprising:
suggesting to the first member and to the second member a location where the activity is to occur.

17. A machine-readable medium comprising instructions, which when implemented by one or more processors perform the operations as claimed in claim 12.

18. A system for organizing activities for members of a network, comprising:
means for identifying an activity based on interest information of two or more members of the network;
means for scheduling the activity based on availability information of the two or more members;
means for suggesting the activity to the two or more members; and
means for confirming or cancelling the activity responsive to receiving attendance information from the two or more members.

19. The system of claim 18, further comprising means for determining a location where the activity is to occur.

20. The system of claim 18, further comprising means for updating the availability information of the two or more members after the activity is confirmed.
